(19) United States
(12) Patent Application Publication
(10) Pub. No.: US 2025/0059783 A1
(43) Pub. Date: Feb. 20, 2025

(54) Scaffold Clamp

(71) Applicant: INTAKS IP Ltd., Auckland (NZ)

(72) Inventor: Peter Chapman, Hamilton (NZ)

(21) Appl. No.: 18/801,076

(22) Filed: Aug. 12, 2024

(30) Foreign Application Priority Data
Aug. 17, 2023 (AU) 2023216843

(51) Int. Cl. E04G 7/28; E04G 5/14

(52) U.S. Cl. CPC E04G 7/28; E04G 5/145; E04G 2007/285

(57) ABSTRACT

A clamp for use in securing a toeboard in scaffolding. The clamp has a laterally extending slot with an associated first screw fastener; and an upwardly extending slot with an associated second screw fastener. The clamp is formed such that the laterally extending slot can be manoeuvred by hand to extend around a longitudinal edge of a scaffolding deck and the first fastener can be screw turned (eg by hand) to press against the scaffolding deck. The clamp is also formed such that a toeboard can be stood up in the upwardly extending slot and the second fastener can be screw turned (eg by hand) to press against the toeboard to secure it to the clamp.

### FIELD OF THE INVENTION

This invention relates to a clamp, preferably for use in providing safety barriers in scaffolding.

### BACKGROUND

It is known to use scaffolding to enable a human workers to more safely operate at heights, for example in the context of building construction, building repairs and painting. A problem with many known scaffolds is that they can be unnecessarily complicated and time consuming to erect. It is accordingly an object of a preferred form of the invention to go at least some way towards addressing this problem.

### Definitions

The terms “comprising” and “having”, if and when used in this document in relation to a combination of features, should not be seen as excluding the option of additional unspecified features or steps. In other words, they should not be interpreted in a limiting way.

Orientational terms, for example lateral, upwardly, top, bottom, etc, if and when used in this document, refer to the orientation the associated features will have when in a normal in-use disposition.

### SUMMARY OF INVENTION

### First Aspect

According to one aspect, the invention is a clamp suitable for use in securing a toeboard in scaffolding, comprising:
a laterally extending slot with an associated first screw fastener; and
an upwardly extending slot with an associated second screw fastener;
the clamp being formed such that:
a) the laterally extending slot can be manoeuvred by hand to extend around a longitudinal edge of a scaffolding deck and the first fastener then screw turned (eg by hand) to press against the scaffolding deck; and
b) a toeboard can be stood up in the upwardly extending slot and the second fastener then screw turned (eg by hand) to press against the toeboard to secure it to the clamp.

The following options apply to the First Aspect of the invention in any and all workable combinations.

Optionally the claim comprises a cavity immediately adjacent to each slot and in each case a removable insert (in one or more pieces) substantially fills the cavity and a respective one of the fasteners passes through the insert.

Optionally the laterally extending slot has a roof comprising a series of downwardly facing teeth or ribs adapted to engage with complimentary teeth or slots of the deck.

Optionally the clamp is in use with the scaffolding to secure the toeboard to the deck, wherein:
a) the laterally extending slot extends around a longitudinal edge of a scaffolding deck and the first fastener has been screw turned (eg by hand) to press against the scaffolding deck; and
b) the toeboard stands in the upwardly extending slot and the second fastener has been screw turned (eg by hand) to press against the toeboard to secure it to the clamp.

Optionally the toeboard comprises two separate boards and these are connected substantially ‘in line’ by an in-line joiner, the joiner having a channel into which the separate boards are fitted and held by way of joiner fasteners that have been screw turned (eg by hand) to press against the separate boards to secure them to the in-line joiner

Optionally the in-line joiner has a cavity running substantially parallel to the channel that receives the toeboard, there being an insert (in one or more pieces) releasably installed in the cavity with one or more of the joiner fasteners passing through the cavity and into the channel.

Optionally the in-line joiner has a roof portion that sits over or against one of the smaller boards.

Optionally at least one corner-joiner supports two toeboards at a corner of the scaffolding, the corner-joiner having a first corner channel and a second corner channel formed such that they are at right angles to one another, the arrangement being such that each of the two toeboards is engaged in a respective one of the corner channels so that the toeboards are also held at right angles to one another, the corner-joiner also having at least a pair of corner-fasteners that have been screw turned (eg by hand) to press against the two toeboards respectively to secure them to the corner-joiner.

Optionally the corner-joiner has a pair of corner cavities each running substantially parallel to a respective one of the corner channels, the arrangement being such that a corner insert (in one or more pieces) is located in each corner cavity and in each case one or more of the corner fasteners passes through the corner insert.

Optionally each corner channel has a roof portion that sits over or against the toeboard located in that channel.

Optionally at least one of the corner channels is open at both ends so that a toeboard can run through and beyond the corner-fastener at each end thereof.

Optionally each corner channel is open at both ends so that in each case a toeboard can run through and beyond the corner-fastener at each end thereof.

Optionally the laterally extending slot is engaged with the deck and is below the upwardly extending slot.

Optionally the toeboard has at least one ridge and at least one complimentary valley arranged such that if/when the toeboard is laid against another substantially similar toeboard the ridge of one toeboard can be caused to nest in the valley of the other toeboard to resist one toeboard sliding across the other.

Optionally at least one ridge is arranged immediately below the first screw fastener so that if a toeboard in that clamp begins to move upwards said ridge runs into the first screw fastener to arrest further upwards movement of that toeboard.

Optionally two of the clamps are used to secure the toeboard to the deck.

### Second Aspect

According to a second aspect, the invention is a clamp suitable for use in securing a toeboard in scaffolding, comprising:
a laterally extending slot with an associated first screw fastener; and
an upwardly extending slot with an associated second screw fastener;
the clamp being formed such that:
c) the laterally extending slot can be manoeuvred by hand to extend around a longitudinal edge of a scaffold crossbar and the first fastener then screw turned (eg by hand) to secure the clamp to the scaffold crossbar; and
d) a toeboard can be stood up in the upwardly extending slot and the second fastener then screw turned (eg by hand) to press against the toeboard to secure it to the clamp; and
e) both the laterally extending slot and the upwardly extending slot can be located above a scaffolding deck such that the clamp extends downwards from the scaffold cross bar.

The following options apply to the Second Aspect of the invention in any and all workable combinations.

Optionally the clamp comprises a cavity immediately adjacent to each slot and in each case a removable insert (in one or more pieces) substantially fills the cavity and a respective one of the fasteners passes through the insert.

Optionally the clamp is in use with the scaffolding to secure the toeboard to the deck, wherein:
a) the laterally extending slot extends around the longitudinal edge of the scaffold crossbar and the first fastener has been screw turned (eg by hand) to secure the clamp to the scaffold crossbar; and
b) the toeboard stands in the upwardly extending slot and the second fastener has been screw turned (eg by hand) to press against the toeboard to secure it to the clamp; and
c) both the laterally extending slot and the upwardly extending slot are located above a scaffolding deck such that the clamp extends downwards from the scaffold cross bar.

Optionally the toeboard comprises two separate boards and these are connected substantially ‘in line’ by an in-line joiner, the joiner having a channel into which the separate boards are fitted and held by way of joiner fasteners that have been screw turned (eg by hand) to press against the separate boards to secure them to the in-line joiner

Optionally the in-line joiner has a cavity running substantially parallel to the channel that receives the toeboards, there being an insert (in one or more pieces) releasably installed in the cavity with one or more of the joiner fasteners passing through the cavity and into the channel.

Optionally the in-line joiner has a roof portion that sits over or against one of the smaller boards.

Optionally at least one corner-joiner supports two toeboards at a corner of the scaffolding, the corner-joiner having a first corner channel and a second corner channel formed such that they are at right angles to one another, the arrangement being such that each of the two toeboards is engaged in a respective one of the corner channels so that the toeboards are also held at right angles to one another, the corner-joiner also having at least a pair of corner-fasteners that have been screw turned (eg by hand) to press against the two toeboards respectively to secure them to the corner-joiner.

Optionally the corner-joiner has a pair of corner cavities each running substantially parallel to a respective one of the corner channels, the arrangement being such that a corner insert (in one or more pieces) is located in each corner cavity and in each case one or more of the corner fasteners passes through the corner insert.

Optionally each corner channel has a roof portion that sits over or against the toeboard located in that channel.

Optionally at least one of the corner channels is open at both ends so that a toeboard can run through and beyond the corner-fastener at each end thereof.

Optionally each corner channel is open at both ends so that in each case a toeboard can run through and beyond the corner-fastener at each end thereof.

Optionally the toeboard has at least one ridge and at least one complimentary valley arranged such that if/when the toeboard is laid against another substantially similar toeboard the ridge of one toeboard can be caused to nest in the valley of the other toeboard to resist one toeboard sliding across the other.

Optionally the at least one ridge is arranged immediately below the first screw fastener so that if a toeboard in that clamp begins to move upwards said ridge runs into the first screw fastener to arrest further upwards movement of that toeboard.

Optionally two of the clamps are in use to secure the toeboard to the deck.

### BRIEF DESCRIPTION OF DRAWINGS

Some preferred embodiments of the invention will now be described by way of example and with reference to the accompanying drawings, of which:

FIG. 1 is an isometric view showing a scaffolding deck fitted with a kickboard by way of a clamp;

FIGS. 2a-2e show the clamp in plan, side, front, opposite side and isometric views, respectively;

FIGS. 3a-3e show a main body part of the clamp in side, isometric, and three part detail views respectively;

FIGS. 4a-4b show 3D prints of the clamp when installed on a scaffold and when uninstalled, respectively;

FIGS. 5a-5b illustrate a toeboard in-line joiner when ready for use with toeboards and also when actually in-use, respectively;

FIGS. 6a-6e show the in-line joiner in plan, side, front, opposite side and isometric views, respectively;

FIGS. 7a-7c illustrate a toeboard corner-joiner in two alternative isometric views and also when in use with toeboards, respectively;

FIGS. 8a-8d show the main body of the corner joiner in plan, side, front and opposite side views respectively;

FIG. 9 is an isometric view of an alternative embodiment of the clamp when engaged with a scaffold cross bar and supporting a toeboard beneath the bar;

FIGS. 10a-10f show a main body portion of the FIG. 9 clamp in plan, part detail, side, front, opposite side and isometric views, respectively;

FIG. 11 illustrates a screw fastener and insert combination used in one or more of the clamps in plan, side, front, opposite side perspective and bottom views, respectively;

FIG. 12 illustrates a further screw fastener and insert combination used in one or more of the clamps in plan, side, front, opposite side perspective and bottom views respectively;

FIG. 13 is a side view showing detail of a toeboard when used with the clamp of FIG. 1; and

FIG. 14 shows a toeboard similar to that of FIG. 13 in part detail, end and isometric views, respectively,

### DETAILED DESCRIPTION

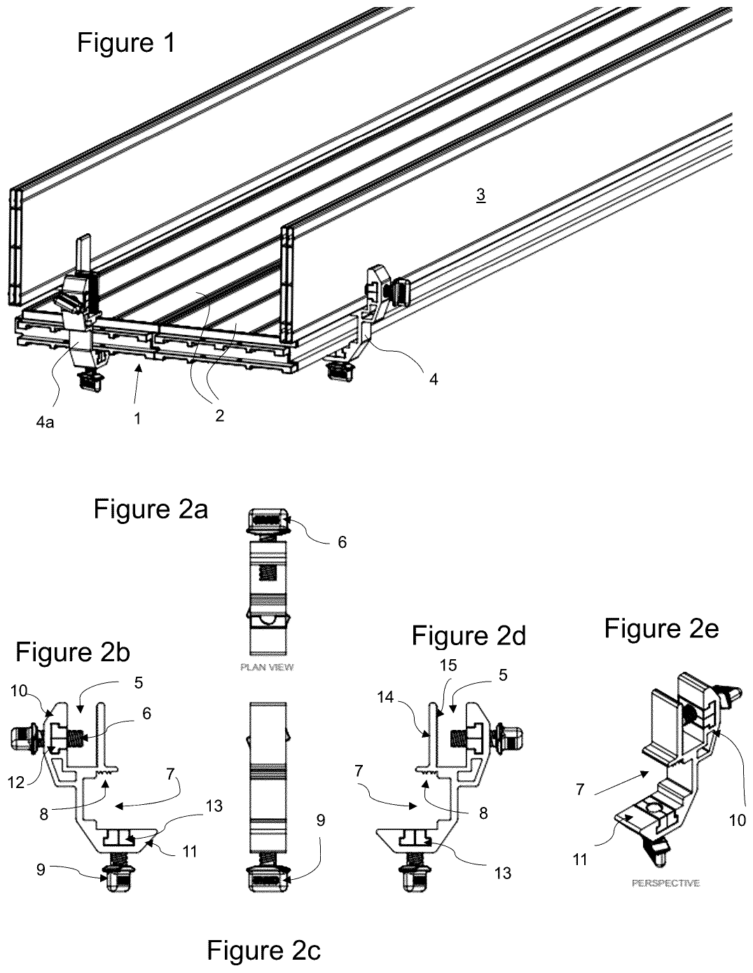

Referring to FIG. 1, a scaffolding deck 1 is formed from a series of planks 2 arranged in parallel fashion. Optionally the planks are metallic, for example formed from aluminium. A side toeboard 3 (alternatively called a kickboard) is secured to the deck 1 for safety by way of a series of clamps 4. In the drawing only one of the clamps 4 is shown engaged with the toeboard 3, although in practice there are preferably multiple of them spaced along and engaged with the deck and toeboard. This ensures a safer and stronger connection between the deck and the toeboard than if only one clamp is used.

As shown, the clamp 4 engages the deck 1 and the toeboard at a position significantly short of each end of the deck. In other words, the clamp 4 is generally centrally located as opposed to being located at the extremities of the deck. Therefore, there need not be any connection between the toeboard 3 and the end-posts (not shown) that hold the deck up off the ground (ie toeboards are normally secured to the end posts).

FIG. 1 also shows a second clamp 4a fixed to an end of the deck 1 but not yet fitted with a toeboard. However, this second clamp 4a is formed and used in the same way as the first one 4.

FIGS. 2a-2e show the clamp 4 from various angles prior to use with the toeboard 3. As illustrated, the clamp 4 has an upwardly extending slot 5 for receiving and supporting the toeboard. When in use in the manner of FIG. 1, the bottom of the toeboard sits in the slot 5, and the top of the toeboard cantilevers upwards from the slot.

As best seen in FIGS. 2b and 2d, the clamp 4 has a horizontally extending bolt 6 that can be screw-turned (eg by hand) to press firmly against the toeboard to prevent it from sliding along the clamp and from lifting free of it.

Referring to FIGS. 2b, 2c and 2e, the clamp 4 also has a horizontally extending slot 7 for receiving an edge of the deck 1 in the way shown in FIG. 1. The roof of this slot has a series of downwardly extending teeth 8 adapted to engage with complimentary grooves in the deck 1 to better facilitate a tight fit.

As best illustrated in FIGS. 2b and 2d, the clamp also has a vertically extending bolt 9 that can be screw-turned (eg by hand) to press firmly against the underside of the edge of the deck to keep the clamp and deck securely engaged with one another.

Referring again to FIGS. 2b and 2d, the bolts 6 and 9 pass through side 10 and lower 11 walls of the slots 5 and 7 respectively. Each of these walls is fitted with a respective removable insert 12, 13. As shown, each insert is generally T shaped and may be formed in one piece, or from two L-shaped pieces arranged back-to-back.

Referring to FIG. 2d, preferably the inner side wall 14 of the slot 5 also has a series of inwardly facing ridges or teeth 15 to facilitate a tight fit with the toeboard 3 when installed in the slot 5.

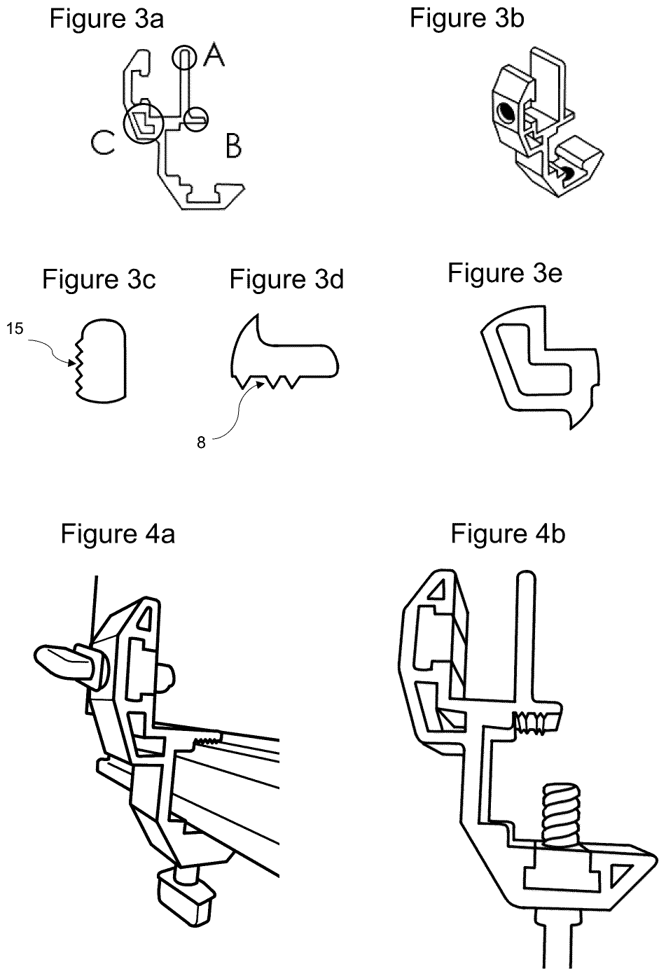

FIGS. 3a-3e show the main body of the clamp 4 before the bolts 6, 9 and the inserts 12, 13 are fitted. FIGS. 3c-e in particular show detail of the parts marked A, B and C in FIG. 3a, including the teeth 8 and 15.

FIGS. 4a-4b show a 3D polymer print of the clamp 4, one when in use with the deck and one when assembled but not yet engaged with the deck. FIG. 4a in particular shows the way the teeth 8 engage complimentary grooves in the deck 1.

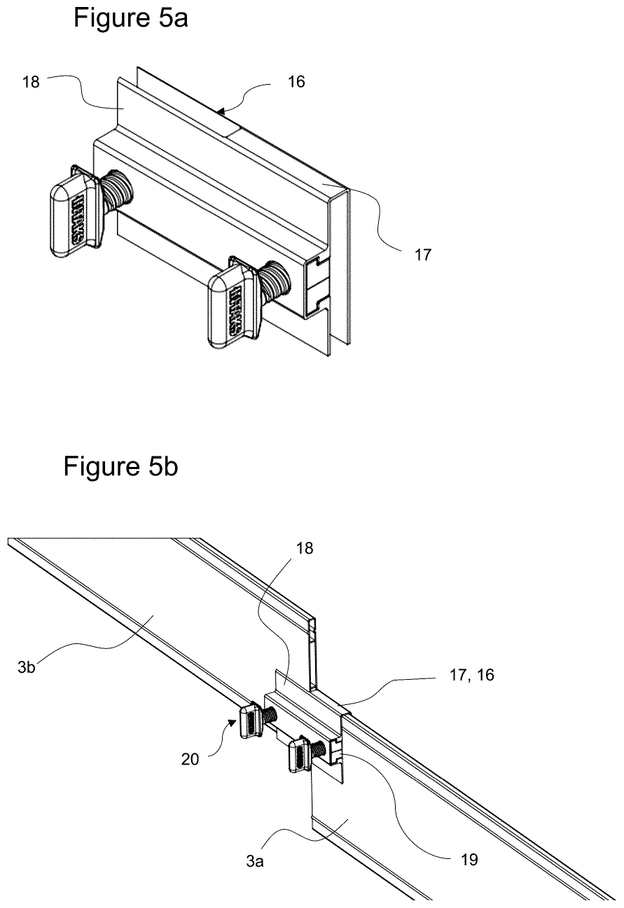

Referring to FIG. 5a, in some cases more than one toeboard 3 may be used to span the full length of the side of the deck, for example two toeboards butted end to end and each engaged with the deck by at least a pair of the clamps 4. To facilitate this an in-line joiner 16 is used to support and hold neighbouring toeboards where their ends butt up against one another. As shown, the right hand-side 17 of the joiner is closed at the top and open at the bottom, and the left-hand side 18 of the joiner is open at both the top and bottom. Referring to FIG. 5b, the arrangement is such that the joiner's right hand-side 17 wraps around the top edge of the right-hand toeboard 3a and the left-hand toeboard 3b can be slid into the left-hand side 18 of the joiner until the two toeboards are butted end-to-end run in the same line. In FIG. 5b the left-hand toeboard is only partially engaged by the joiner 16, being in the process of sliding down into the joiner 16, but in some embodiments that may its final disposition, ie one higher than the other. In alternative embodiments the in-line joiner 16 may be used in an inverted or opposite disposition so that it wraps around the bottom edge of the toeboard rather than its top edge.

Still with FIGS. 5a and 5b, the main body of the joiner has a side channel which accommodates inserts 19 and bolts 20 of the same type described above so as to facilitate a tight fit between the joiner 16 and the toeboards 3a and 3b.

In some embodiments of the invention the joiner 16 may be used to secure one toeboard higher than the other, depending on the user's needs.

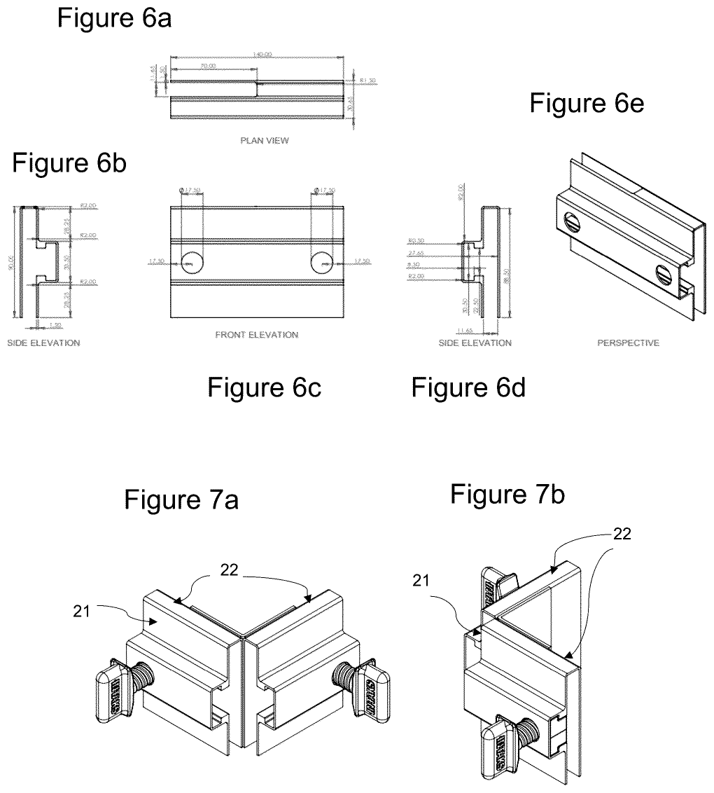

FIGS. 6a-6d show detail of the main body of the joiner 16 without the inserts 19 and bolts 20.

FIGS. 7a-7b illustrate a corner joiner 21 for securing toeboards where they meet at a 90° angle at a corner of the scaffold's deck 1. The corner joiner 21 is formed substantially the same as the in-line joiner, except that the two halves of it are at right angles and both the left-hand and right-hand sides are closed at the top (see label 22) and open at the bottom, or vice versa, depending on which way up the joiner 21 is used.

FIG. 7c illustrates a corner joiner 21 when in use with toeboard 3a and 3b at a corner of the deck 1 (not shown). As the main body of each corner joiner is open at each end, if necessary one of the toeboards 3a, 3b can cantilever beyond its joiner 21. In other words, it is not necessary for the toeboard to be sized to terminate exactly at the corner of the joiner 21.

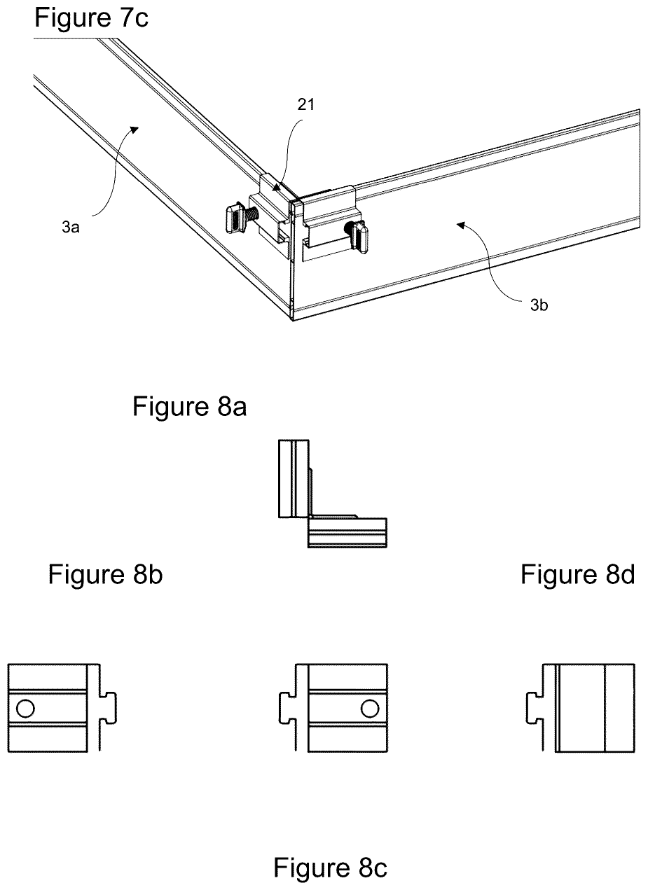

FIGS. 8a-8d illustrate detail of the corner joiner 21 from different angles.

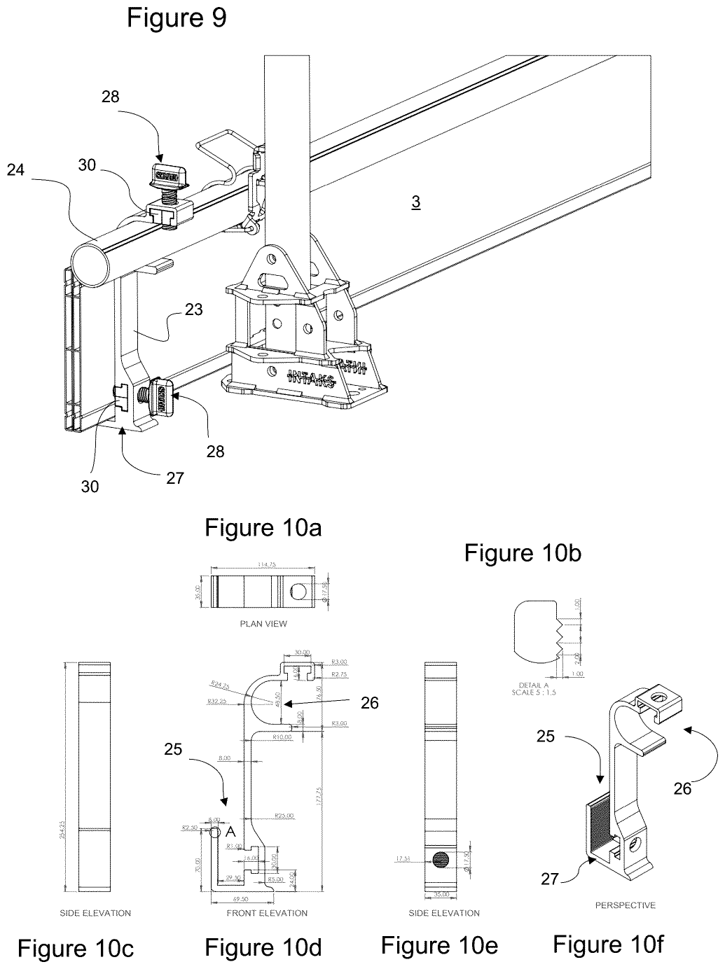

Referring to FIG. 9 and to FIGS. 10a-f, in some embodiments of the invention there is a clamp 23 that fastens a toeboard 3 to a cross bar 24 of scaffolding rather than to its deck. In other words, the clamp 23 hangs down from the crossbar 24 and holds the toeboard 3 upright without it needing to be secured to the deck. To enable this the clamp 23 has an upwardly facing slot 25 (see FIGS. 10d and 10f) that receives a lower edge of the toeboard 3. The clamp 23 also has a laterally facing slot 26 (see FIGS. 10d and 10f) that engages the crossbar 24. The arrangement is such that the base 27 of the upwardly facing slot 25 sits on the deck. Alternative, the clamp may sit on a permanent floor, for example a concrete or wooden floor of a building under construction or repair, rather than a scaffold deck. The clamp 23 has screw fastening bolts 28 and inserts 30 similar to those mentioned above. The bolts can be screwed into the main body of the clamp 23 to press against the toeboard 3 and the crossbar 24 for a secure tight engagement between these. Alternatively, the bolts may extend at least partially along the side of the crossbar 24 opposite to the toeboard to prevent the clamp pulling away from crossbar, without necessarily having to positively press against the crossbar.

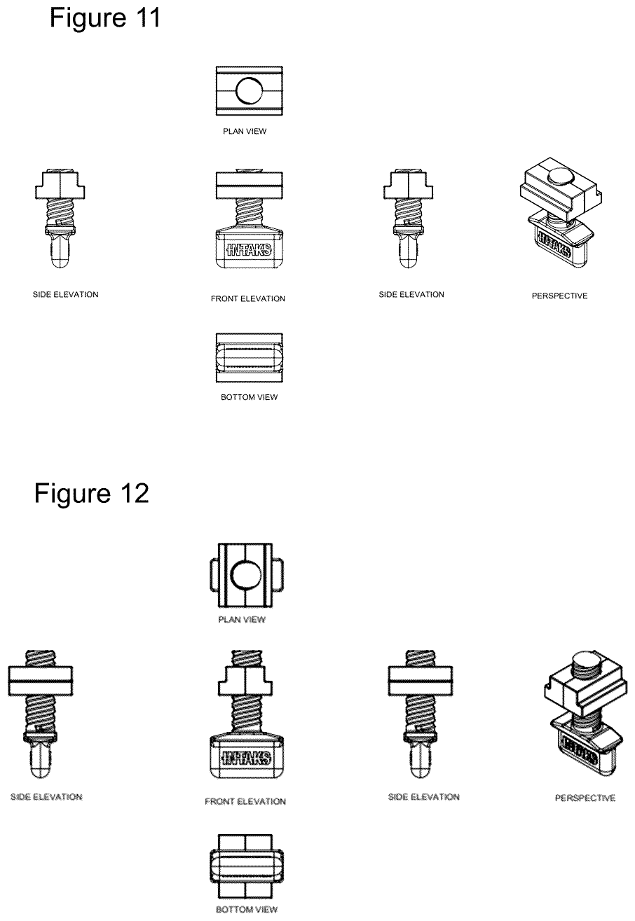

Referring to FIGS. 11 and 12, these illustrate various views of the bolts and inserts described above, in different sizes depending on which clamps and joiners that they are used with.

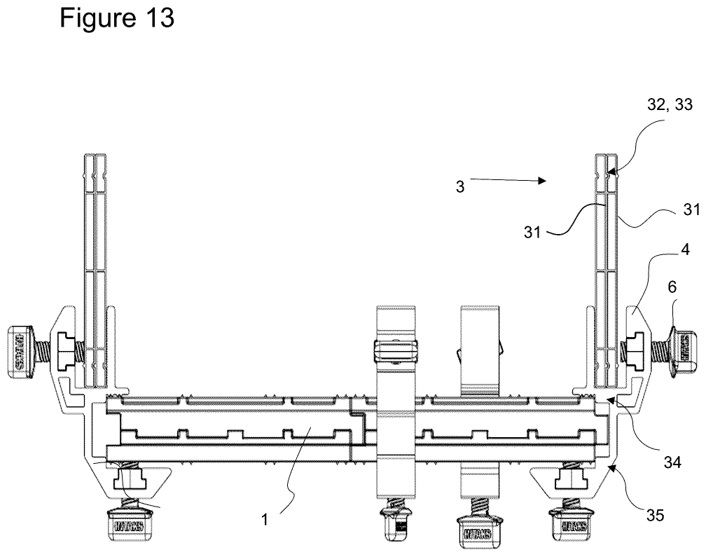

Referring to FIG. 13, this illustrates detail of a preferred embodiment of the invention where the clamp 4 of FIG. 1 is used to secure a toeboard to the deck 1. In this case two toeboards 31 overlap and, where they overlap, they lay against one another face-to-face. These toeboards 31 each have a series of elongate ridges 32 and complimentary elongate valleys 33 so that when the toeboards 31 are flat against one another the ridges of one nest or otherwise locate in the valleys of the other to resist movement of one toeboard with respect to the other. Preferably for each clamp one of the ridges is arranged immediately below the bolt 6 so that if the toeboard in that clamp begins to move upwards the ridge runs into the bolt 6 to arrest further upwards movement of the toeboard. In other embodiments the ridges and valleys may be substituted by dimples and complimentary recesses.

The ability of toeboards to overlap means that they need not be an exact size to be useful with the scaffold deck. For example, if two toeboards are use where, if butted exactly end to end, they would be too long for the deck, they can be overlapped between the ends of the deck. The ridges and valleys also facilitate convenient stable stacking of the toeboards 31 for storage or transport.

As also shown, to facilitate a secure fit, the deck 1 sits in upper and lower steps 34, 35.

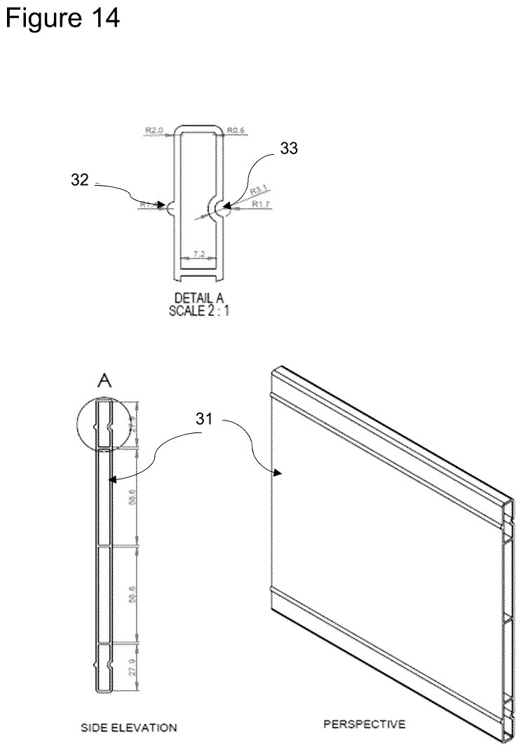

FIG. 14 shows further detail of preferred forms of one of the toeboards 31.

Preferably the clamps described above are metallic, except that the inserts and/or bolts may be made of a suitable alternative, for example a durable synthetic polymer material. Alternatively the clamp may be made entirely, or substantially, of non-metallic material, for example a suitable polymer based material.

While some preferred embodiments of the invention have been described by way of example it should be appreciated that modifications and improvements can occur without departing from the scope of the following claims.

In terms of disclosure, this document hereby discloses each item, feature or step mentioned herein in combination with one or more of any of the other item, feature or step disclosed herein, in each case regardless of whether such combination is claimed.

1. A clamp suitable for use in securing a toeboard in scaffolding, comprising:
a laterally extending slot with an associated first screw fastener; and
an upwardly extending slot with an associated second screw fastener;
the clamp being formed such that:
a) the laterally extending slot can be manoeuvred by hand to extend around a longitudinal edge of a scaffolding deck and the first fastener then screw turned to press against the scaffolding deck; and
b) a toeboard can be stood up in the upwardly extending slot and the second fastener then screw turned to press against the toeboard to secure it to the clamp.

2. A clamp according to claim 1, comprising a cavity immediately adjacent to each slot and in each case a removable insert substantially fills the cavity and a respective one of the fasteners passes through the insert.

3. A clamp according to claim 2, wherein the laterally extending slot has a roof comprising a series of downwardly facing teeth or ribs adapted to engage with complimentary teeth or slots of the deck.

4. A clamp according to claim 1, in use with the scaffolding to secure the toeboard to the deck, wherein:
a) the laterally extending slot extends around a longitudinal edge of a deck of the scaffolding and the first fastener has been screw turned to press against the deck; and
b) the toeboard stands in the upwardly extending slot and the second fastener has been screw turned to press against the toeboard to secure it to the clamp.

5. A clamp according to claim 4, comprising:
a) a cavity immediately adjacent to each slot where in each case a removable insert substantially fills the cavity and a respective one of the fasteners passes through the insert; and
b) the laterally extending slot has a roof comprising a series of downwardly facing teeth or ribs engaged with complimentary teeth or slots of the deck.

6. A clamp according to claim 4, wherein the toeboard comprises two separate boards and these are connected substantially ‘in line’ by an in-line joiner, the joiner having a channel into which the separate boards are fitted and held by way of joiner fasteners that have been screw turned to press against the separate boards to secure them to the in-line joiner.

7. A clamp according to claim 4, wherein the in-line joiner has a cavity running substantially parallel to the channel that receives the toeboard, there being an insert releasably installed in the cavity with one or more of the joiner fasteners passing through the cavity and into the channel.

8. A clamp according to claim 6, wherein the in-line joiner has a roof portion that sits over or against one of the separate boards.

9. A clamp according to claim 4, wherein at least one corner-joiner supports two toeboards at a corner of the scaffolding, the corner-joiner having a first corner channel and a second corner channel formed such that they are at right angles to one another, the arrangement being such that each of the two toeboards is engaged in a respective one of the corner channels so that the toeboards are also held at right angles to one another, the corner-joiner also having at least a pair of corner-fasteners that have been screw turned to press against the two toeboards respectively to secure them to the corner-joiner.

10. A clamp according to claim 9, wherein:
a) the corner-joiner has a pair of corner cavities each running substantially parallel to a respective one of the corner channels, the arrangement being such that a corner insert is located in each corner cavity and in each case one or more of the corner fasteners passes through the corner insert;
b) each corner channel has a roof portion that sits over or against the toeboard located in that channel;
c) at least one of the corner channels is open at both ends so that a toeboard can run through and beyond the corner-fastener at each end thereof;
d) the laterally extending slot is engaged with the deck and is below the upwardly extending slot;
e) the toeboard has at least one ridge and at least one complimentary valley arranged such that the toeboard is laid against another substantially similar toeboard and the ridge of one toeboard nests in the valley of the other toeboard to resist one toeboard sliding across the other; and
f) the at least one ridge is arranged immediately below the first screw fastener so that if a toeboard in that clamp begins to move upwards said ridge runs into the first screw fastener to arrest further upwards movement of that toeboard.

11. A clamp suitable for use in securing a toeboard in scaffolding, comprising:
a laterally extending slot with an associated first screw fastener; and
an upwardly extending slot with an associated second screw fastener;
the clamp being formed such that:
a) the laterally extending slot can be manoeuvred by hand to extend around a longitudinal edge of a scaffold crossbar and the first fastener then screw turned (eg by hand) to secure the clamp to the scaffold crossbar; and
b) a toeboard can be stood up in the upwardly extending slot and the second fastener then screw turned (eg by hand) to press against the toeboard to secure it to the clamp; and
c) both the laterally extending slot and the upwardly extending slot can be located above a scaffolding deck such that the clamp extends downwards from the scaffold cross bar.

12. A clamp according to claim 11, comprising a cavity immediately adjacent to each slot and in each case a removable insert substantially fills the cavity and a respective one of the fasteners passes through the insert.

13. A clamp according to claim 11, in use with the scaffolding to secure the toeboard to the deck, wherein:
a) the laterally extending slot extends around the longitudinal edge of the scaffold crossbar and the first fastener has been screw turned to secure the clamp to the scaffold crossbar; and
b) the toeboard stands in the upwardly extending slot and the second fastener has been screw turned to press against the toeboard to secure it to the clamp; and
c) both the laterally extending slot and the upwardly extending slot are located above a scaffolding deck such that the clamp extends downwards from the scaffold cross bar.

14. A clamp according to claim 13, wherein the toeboard comprises two separate boards and these are connected substantially ‘in line’ by an in-line joiner, the joiner having a channel into which the separate boards are fitted and held by way of joiner fasteners that have been screw turned to press against the separate boards to secure them to the in-line joiner.

15. A clamp according to claim 14, wherein the in-line joiner has a cavity running substantially parallel to the channel that receives the toeboards, there being an insert releasably installed in the cavity with one or more of the joiner fasteners passing through the cavity and into the channel.

16. A clamp according to claim 14, wherein the in-line joiner has a roof portion that sits over or against one of the smaller boards.

17. A clamp according to claim 14, wherein:
a) at least one corner-joiner supports two toeboards at a corner of the scaffolding, the corner-joiner having a first corner channel and a second corner channel formed such that they are at right angles to one another, the arrangement being such that each of the two toeboards is engaged in a respective one of the corner channels so that the toeboards are also held at right angles to one another, the corner-joiner also having at least a pair of corner-fasteners that have been screw turned to press against the two toeboards respectively to secure them to the corner-joiner;
b) the corner-joiner has a pair of corner cavities each running substantially parallel to a respective one of the corner channels, the arrangement being such that a corner insert is located in each corner cavity and in each case one or more of the corner fasteners passes through the corner insert;
c) each corner channel has a roof portion that sits over or against the toeboard located in that channel; and
d) at least one of the corner channels is open at both ends so that a toeboard runs through and beyond the corner-fastener at each end thereof.

18. A clamp according to claim 14, wherein the toeboard has at least one ridge and at least one complimentary valley arranged such that the toeboard is laid against another substantially similar toeboard the ridge of one toeboard to nest in the valley of the other toeboard to resist one toeboard sliding across the other.

19. A clamp according to claim 18, wherein the at least one ridge is arranged immediately below the first screw fastener so that if a toeboard in that clamp begins to move upwards said ridge runs into the first screw fastener to arrest further upwards movement of that toeboard.

20. Two clamps, each being according to claim 14, in use to secure the toeboard to the deck.
